(19) United States
(12) Patent Application Publication
(10) Pub. No.: US 2009/0025412 A1
(43) Pub. Date: Jan. 29, 2009

(54) ADJUSTING SYSTEM FOR ADJUSTING CONDITIONS IN PASSENGER COMPARTMENT OF AUTOMOTIVE VEHICLE

(75) Inventor: Satoshi Takehisa, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/164,438

(22) Filed: Jun. 30, 2008

(30) Foreign Application Priority Data
Jul. 23, 2007 (JP) 2007-191146

(51) Int. Cl. B60H 1/32

(52) U.S. Cl. 62/244; 307/10.1; 701/36

(57) ABSTRACT

A system for adjusting or improving conditions in a passenger compartment of an automotive vehicle includes a remote controller and an on-board system mounted on an automotive vehicle. The on-board system includes a communication device, a window-view detector, an air-condition detector and a battery capacity detector. A command to adjust or improve the conditions in the passenger compartment to desired conditions is wirelessly transmitted from the remote controller to the on-board communication device. Upon receipt of the command, a residual capacity of an on-board battery and the conditions in the passenger compartment are detected by the on-board detectors. If the residual capacity of the on-board battery is sufficiently high, a full control is performed for adjusting the conditions, while a limited control is performed if the residual battery capacity is low. The conditions including temperature, humidity and transparency through the windows are properly controlled before a driver gets into the vehicle while saving the battery capacity for driving.

### CROSS-REFERENCE TO RELATED APPLICATION

This application is based upon and claims benefit of priority of Japanese Patent Application No. 2007-191146 filed on Jul. 23, 2007, the content of which is incorporated herein by reference.

### BACKGROUND OF THE INVENT ION

1. Field of the Invention

The present invention relates to a system for adjusting conditions in a passenger compartment of an automotive vehicle before driving the vehicle.

2. Description of Related Art

An example of a system for adjusting conditions in a passenger compartment of an automotive vehicle based on a command from a user before driving is disclosed in JP-A-2004-256092. In this system, either a ventilation device or an air-conditioner is operated upon receipt of the command to adjust temperature in the passenger compartment. The command is wirelessly transmitted from a mobile terminal to an on-board system. It is intended to save energy of an on-board battery by selecting either one of the ventilation device or the air-conditioner. Although this system is able to reduce the temperature in the passenger compartment before the vehicle is driven, window-view conditions cannot be improved even if the windows are covered with frost or dew.

### SUMMARY OF THE INVENTION

The present invention has been made in view of the above-mentioned problem, and an object of the present invention is to provide an improved adjusting system that is able to adjust air-conditions and window-view conditions in a passenger compartment before driving a vehicle.

The adjusting system according to the present invention is composed of a remote controller and an on-board system that includes a wireless communication device, a window-view detector, an air-condition detector and a battery capacity detector. A command to adjust conditions in a passenger compartment of an automotive vehicle to desired conditions is wirelessly transmitted from the remote controller to the on-board system before a driver gets into the vehicle. The command is transmitted when a user operates the remote controller. The conditions to be adjusted are air-conditions including temperature and humidity in the passenger compartment and window-view conditions such as visibility through the windows.

The battery capacity detector detects a residual capacity of the on-board battery upon receipt of the command from the remote controller. The air-conditions and the window-view conditions are controlled to desired conditions by operating on-board devices, such as an air-conditioner, defogger and so on. If the battery capacity is sufficiently high, i.e., higher than a predetermined level, a full control is performed for adjusting the conditions. If the battery capacity is low, i.e., lower than a predetermined level, a limited control is performed. In the full control, for example, temperature and humidity in the passenger compartment are adjusted by operating an air-conditioner that consumes a large amount of battery power in the limited control, for example, only the window-view conditions are improved by operating a defogger or a deicer that does not consume high power.

According to the present invention, conditions in the passenger compartment, such as temperature, humidity and visibility through the windows, are adjusted or improved to desired levels before a drive gets into the vehicle. If the residual battery capacity is not sufficient, only the window-view conditions are adjusted to thereby save the battery capacity for driving. Other objects and features of the present invention will become more readily apparent from a better understanding of the preferred embodiment described below with reference to the following drawings.

### BRIEF DESCRIPTION OF THE DRAWINGS

FIG. 1 is a block diagram showing an entire system for adjusting conditions in a passenger compartment of an automotive vehicle according to the present invention;

FIG. 2 is a flowchart showing a process of a full control of the adjusting system when a residual battery capacity is sufficiently high;

FIG. 3 is a flowchart showing a process of a limited control of the adjusting system when a residual battery capacity is lower than a predetermined level; and

FIG. 4 is a modified example of the limited control shown in FIG. 3.

### DETAILED DESCRIPTION OF THE PREFERRED EMBODIMENT

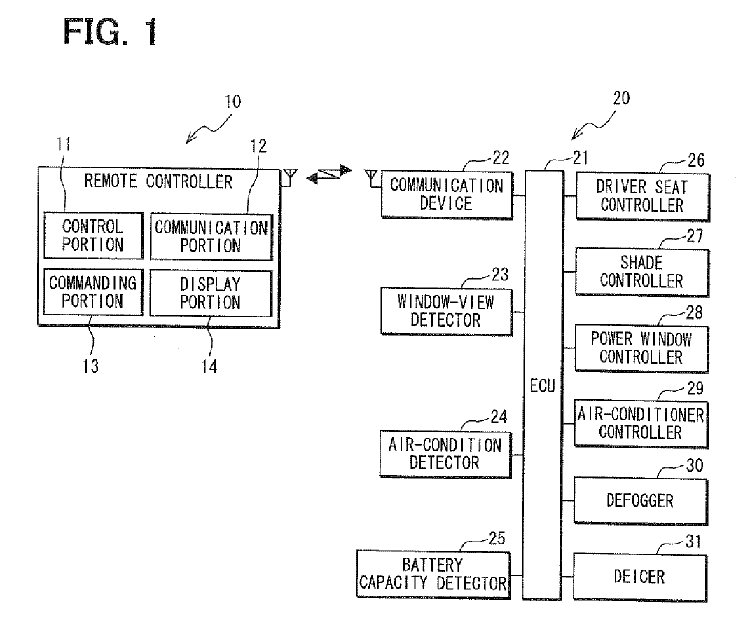

A preferred embodiment of the present invention will be described with reference to FIGS. 1-3. As shown in FIG. 1, a system for adjusting conditions in a passenger compartment of an automotive vehicle is composed of an on-board system 20 and a remote controller 10. The on-board system 20 adjusts conditions in a passenger compartment, including air-conditions and window-view conditions, upon receipt of a command from the remote controller. The command is wirelessly transmitted to the on-board system before driving, so that comfortable conditions are provided for a driver before the vehicle is driven.

The remote controller 10 includes a control portion 11, a commanding portion 13 for generating commands, a communication portion 12 for wirelessly communicating with the on-board system 20, and a display portion 14 (such as a liquid crystal display panel) for displaying information. The remote controller 10 is operated by a user to transmit a command to the on-board system 20.

Conditions in a passenger compartment may become improper for a driver or a passenger while the vehicle is not in operation. For example, temperature in the passenger compartment may be too high and/or a windshield is covered with frost or dew. If these improper conditions are improved after the vehicle is started to be driven, a certain period of time is required. The present invention intends to provide proper conditions for a driver or a passenger before starting the vehicle. For this purpose, a user transmits a command to prepare proper conditions in the passenger compartment before boarding the vehicle. Although a remote controller 10 is used for wirelessly transmitting a command in this embodiment, some other wireless communication systems, such a mobile phone, a personal computer or a personal digital assistant may be used. The communication between such a mobile terminal and the on-board system may be performed through infrared or an internet system.

The on-board system 20 includes an electronic control unit (ECU) 21, a communication device 22, a window-view detector 23, an air-condition detector 24 and a battery capacity detector 25. The on-board system 20 further includes a driver seat controller 26, a shade controller 27, a power window controller 28, an air-conditioner controller 29, a defogger controller 30 and a deicer controller 31. The ECU 21 that includes a CPU and memory devices controls an entire operation of the on-board system 20. For example, the ECU 21 controls operation of an air-conditioner based on a command signal transmitted from the remote controller 10 and signals fed from the window-view detector 23 and the air-condition detector 24.

The communication device 22 performs wireless communication with the remote controller 10, and a command received from the remote controller 10 is fed to ECU 21. The window-view detector 23 detects visibility through windows such as a windshield. The window-view detector 23 may be composed of a dew sensor on a window surface which detects the dew based on a resistance change and/or a ultrasonic sensor which detects transparency of a window based on reflected ultrasonic rays. Various devices, which are able to detect transparency of a window, may be used as the window-view detector.

The air-condition detector 24 detects air-conditions in a passenger compartment and feeds signals representing the air conditions to the ECU 21. The air-condition detector 24 may include an in-room temperature sensor and an outside temperature sensor, both composed of a thermistor or the like, an in-room humidity sensor composed of a pair of electrodes having dielectric material interposed therebetween, and a sunshine sensor for detecting an amount of sunshine composed of a photo-diode or the like.

The battery capacity detector 25 detects a residual battery capacity and feeds the detected results to the ECU 21. The battery capacity detector 25 may be composed of a device for measuring a specific gravity of electrolytic solution in a battery or a device for measuring an entire weight of a battery. Alternatively, the battery capacity detector 25 may be composed of a computer for measuring an accumulated amount of charge and discharge. The battery capacity may be detected by measuring current that flows between two terminals of a battery when two terminals are momentarily shorted to thereby measure a internal resistance.

The driver seat controller 26 includes a motor driven according to a signal from the ECU 21 to move the driver seat frontward or backward in a driving direction of a vehicle. The shade controller 27 opens or closes a shade of the vehicle to control amount of sunshine according to a signal from the ECU 21. The power window controller 28 includes a motor that opens or closes a window according to a signal from the ECU 21.

The air-conditioner controller 29 controls operation of an air-conditioner according to signals from the ECU 21. The air-conditioner is a known device that controls temperature in the passenger compartment and supplies controlled air to the windshield to remove frost and dew thereon (this function is referred to as a defroster). The defogger controller 30 controls an amount of current supplied to heater wires disposed on a rear window to remove frost on the rear window according to signals from the ECU 21. The deicer controller 31 controls an amount of current supplied to heaters disposed at bottom portions of the windshield and the rear window to remove ice formed thereon according to signals from the ECU 21.

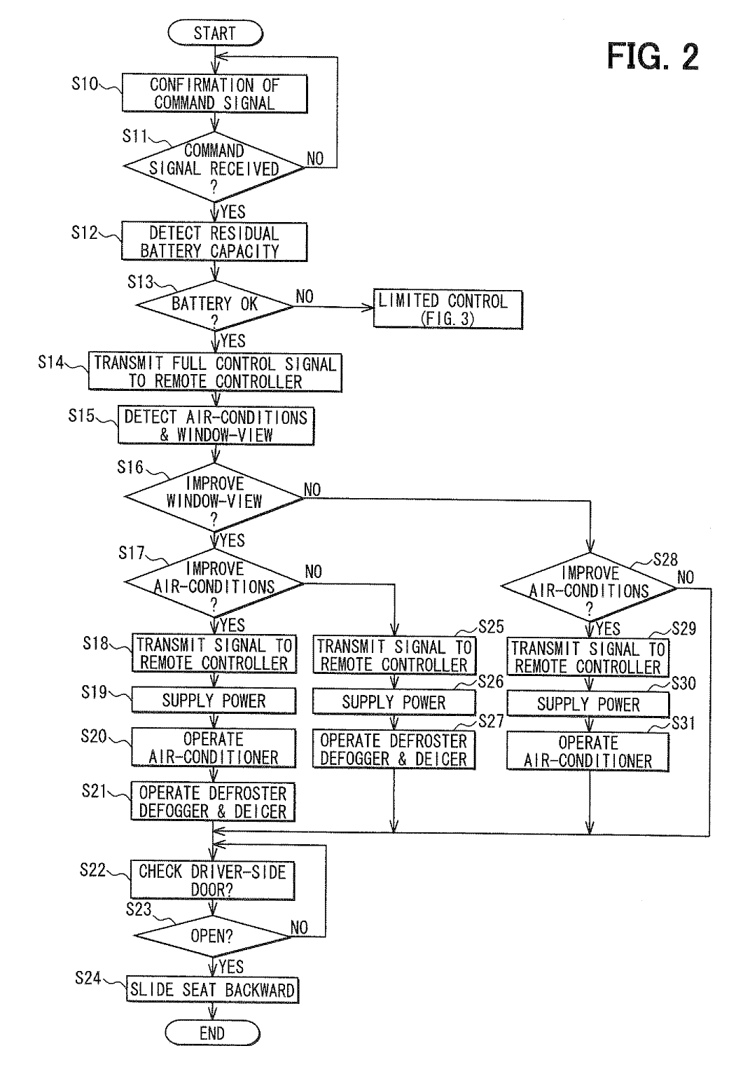

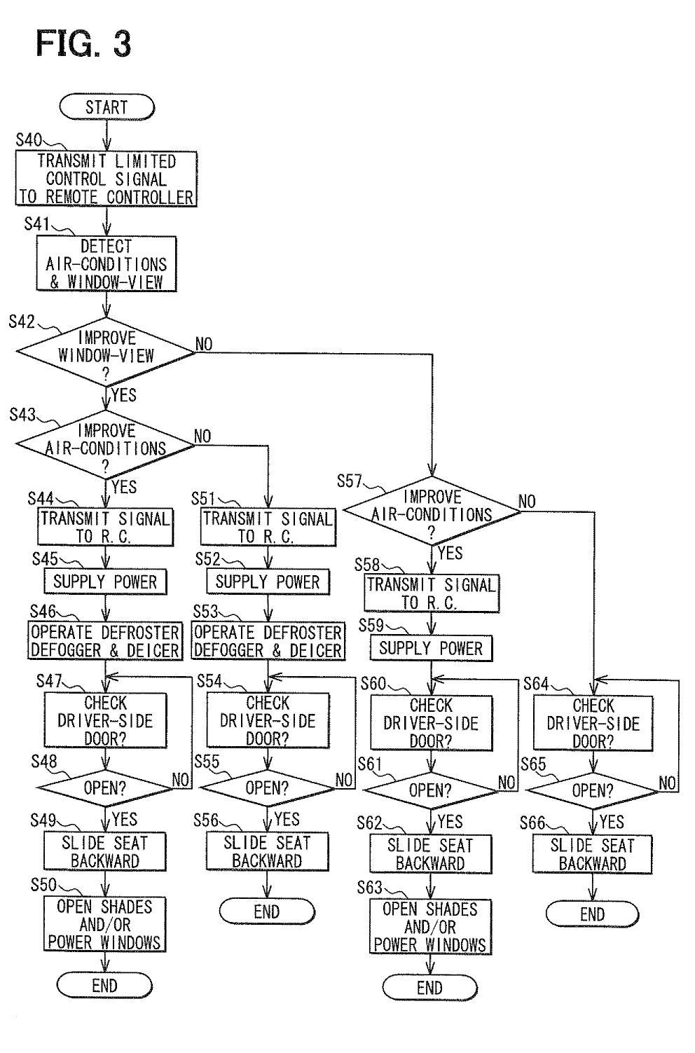

Now, a process of adjusting conditions in the passenger compartment will be described with reference to FIGS. 2 and 3. FIG. 2 shows a full control process which is performed when a residual battery capacity is higher than a predetermined level. FIG. 3 shows a limited control process which is performed when the residual battery capacity is lower than the predetermined level. The conditions in the passenger compartment include air conditions such as temperature and humidity, and window-view conditions, i.e., transparency condition of the windows.

With reference to FIG. 2, the full control process of adjusting the conditions in the passenger compartment will be described. This process is performed when electric power is supplied to the on-board system 20. At step S10, a command from the controller 10 is confirmed. At step S11, whether the command to adjust the conditions in the passenger compartment is received from the controller 10 or not is checked. If the command is received, the process proceeds to step S12. If not, the process returns to step 10 to repeat steps S10 and S11. The command is wirelessly transmitted from the controller 10 to the communication device 22 of the on-board system 20 upon operation of the remote controller by a user. This command is transmitted to improve compartment conditions before the vehicle is driven.

At step S12, the residual battery capacity is confirmed. At step S13, whether the residual battery capacity is higher than a predetermined level is checked by the battery capacity detector 25. If the residual battery capacity is higher than the predetermined level, the process proceeds to step to S14. If not, the limited control process shown in FIG. 3 is performed. The full control process that consumes a relatively high power of the battery is avoided to reserve a battery capacity necessary for driving. Instead, the limited control (explained later with reference to FIG. 3) is performed.

At step S14, information showing commencement of the full control is transmitted to the remote controller 10 to display it on the display portion 14. In this manner, the user is informed that the full control process is going to be performed. The step S14, however, may be eliminated because this is not absolutely necessary. At step 315, the air conditions in the compartment and the window-view conditions are detected. At step S16, whether adjustment (or improvement) of the window-view conditions is necessary or not is determined, i.e., whether the visibility through the windows is sufficiently high with reference to a predetermined level is checked. If the adjustment of the window-view is necessary, the process proceeds to step S17. If not, the process proceeds to step S28.

At step S17, whether adjustment (improvement) of the air conditions in the passenger compartment is necessary or not is determined, comparing with predetermined conditions. If the adjustment of the air conditions is necessary, the process proceeds to step S18. If not, the process proceeds to step S25. At step S18, information regarding the detected air conditions and window-view conditions is transmitted to the remote controller 10 to display it on the display panel 14. This step may be eliminated because this is preferable but not absolutely necessary.

At step S19, electric power is supplied from the battery to devices to be operated according to detecting results of the air conditions and window-view conditions. At step S20, the air-conditioner is operated to adjust temperature and humidity in the passenger compartment. At step S21, the defroster, the defogger and the deicer (whichever necessary to adjust the window-view conditions to the predetermined level) are operated. That is, the conditioned air is supplied to the windshield (the defroster), and electric power is supplied to the heaters of the defogger and the deicer.

At step S22, the driver-side door condition is checked. At step S23, whether the driver-side door is opened or not is determined. If the driver-side door is opened, the process proceeds to step S24. If not, the process returns to step S22 to repeat the steps S22 and S23. At step S24, the driver seat is moved backward by operating the driver seat controller 26. Then, the process comes to the end. It is presumed that the driver is going to sit on the driver seat when the driver-side door is opened. To provide the drive with a sufficient space to get into the vehicle, the driver seat is moved backward.

If it is determined that the window-view adjustment is necessary (step S16), and the adjustment of the air conditions is not necessary (step 517), the process proceeds to step S25. At step S25, information showing that only the window-view adjustment is necessary is transmitted to the remote controller 10. At step 26, electric power is supplied from the battery to devices to be operated to adjust the window-view. At step S27, the defroster, the defogger and the deicer (whichever necessary to adjust the window-view conditions to the predetermined levels) are operated in the same manner as in step S21.

If it is determined that the adjustment of the window-view conditions is not necessary (step S16), the process proceeds to step S28. At step S28, whether the adjustment of the air conditions in the passenger compartment is necessary or not is determined. If the adjustment of the air conditions is necessary, the process proceeds to step S29. If not, the process directly proceeds to step S22. At step S29, information showing that the adjustment of the air conditions is necessary is transmitted to the remote controller 10 to notify the user. At step S30, electric power is supplied to the air-conditioner. At step S31, the air-conditioner is operated according to signals from the ECU 21 to adjust the temperature and humidity in the passenger compartment to the predetermined level. Then, the process proceeds to step S22 to perform steps S22-S24 in the same manner as explained above. Then, the process comes to the end.

As described above, the air conditions in the passenger compartment and the window-view conditions are adjusted to proper levels before the driver gets into the vehicle. When the residual battery capacity is sufficiently high to drive a power-consuming air-conditioner, the full control is performed as described above. When the residual battery capacity is not sufficient, the limited control is preformed, which is described below with reference to FIG. 3.

FIG. 3 is a flowchart showing the limited control process which is performed when the residual battery capacity is lower than the predetermined level. At step S40, information showing commencement of the limited control process is transmitted to the remote controller 10 to notify the user. The step S40 may be eliminated because this process is not necessary though it is preferable. At step S41, the air conditions in the compartment and the window-view conditions are detected in the same manner as in step S15. At step S42, whether adjustment or improvement of the window-view conditions is necessary or not is determined. If the window-view adjustment is necessary, the process proceeds to step S43. If not, the process proceeds to step 357.

At step S43, whether adjustment of the air conditions in the compartment is necessary or not is determined based on detection results of the air condition detector 24. If the adjustment of the air conditions is necessary, the process proceeds to step S44. If not, the process proceeds to step S51. At step S44, information showing that both of the adjustments of air conditions and window-view are necessary is transmitted to the remote controller 10 to notify the user. At step S45, electric power is supplied to devices to be operated according to the detection results. At step S46, the defroster, the defogger and the deicer (whichever necessary to improve the window-view conditions) are operated according to signals from the ECU 21.

At step S47, states of the driver-side door is confirmed. At step S48, whether the driver-side door is opened or not is determined. If the driver-side door is opened, the process proceeds to step S49. If not, the process returns to step S47 to repeat steps S47 and S48. At step S50, the driver seat is moved backward. At step S50, shades of the windows and/or power windows are operated to adjust temperature in the passenger compartment according to the detection results of the air-condition detector 24. More particularly, when the compartment temperature is higher than a predetermined level, the power windows are opened by the power window controller 28. When the compartment temperature is lower than the predetermined level, the shades are opened by the shade controller 27 to raise the temperature by increasing the sunshine. In this manner, the compartment temperature can be controlled in the limited control process without consuming a large amount of electric power. Then, the process comes to the end.

If it is determined that adjustment of the window-view conditions is necessary (step S42) and that adjustment of the air conditions is not necessary (step S43), the process proceeds to step S51. The same operations performed at steps S44 to S49 are performed in steps S51-S56. However, the operation performed at step S50 is not performed because the adjustment of the air conditions is not necessary in this case. Then, the process comes to the end.

If it is determined that the adjustment of the window-view conditions is not necessary at step S42, the process proceeds to step S57. At step S57, whether the adjustment of air conditions in the passenger compartment is necessary or not is determined. If the adjustment of the air conditions in the passenger compartment is necessary, the process proceeds to step S58, where information regarding the detected air conditions are transmitted to the remote controller 10 to notify the user. At step S59, electric power is supplied to devices to be operated according to the detection results of the air condition detector 24. Then, the process proceeds to step S60. The same operations performed at steps S47-S50 are performed at steps S60-S63. Then, the process comes to the end.

If it is determined that the adjustment of the window-view conditions is not necessary (step S42) and that the adjustment of the air conditions in the passenger compartment is not necessary (step S57), the process proceeds to step S64. The same operations performed at steps S54-S56 are performed at steps S64-S66. Then, the process comes to the end.

As described above, in the limited control process the air conditions in the passenger compartment are adjusted, when such is necessary, by operating only the power windows and/or window shades. The air-conditioner requiring a large amount of power is not operated. Therefore, the battery power necessary for driving the vehicle is not consumed in the pre-operation of the on-board devices. As described above, the full control process or the limited control process is selectively performed according to the residual battery capacity detected by the battery capacity detector 25.

The full control process shown in FIG. 2 and the limited control process shown in FIG. 3 may be variously modified. For example, only the defogger and the deicer may be used for adjusting the window-view conditions when the residual battery capacity is low, while using all of the defroster, the defogger and the deicer when the residual battery capacity is high. In this manner, an amount of battery power consumed is further suppressed. In the limited control process, either the way of adjusting the air conditions or the way of adjusting the window-view conditions, or both, may be simplified to suppress battery power consumption.

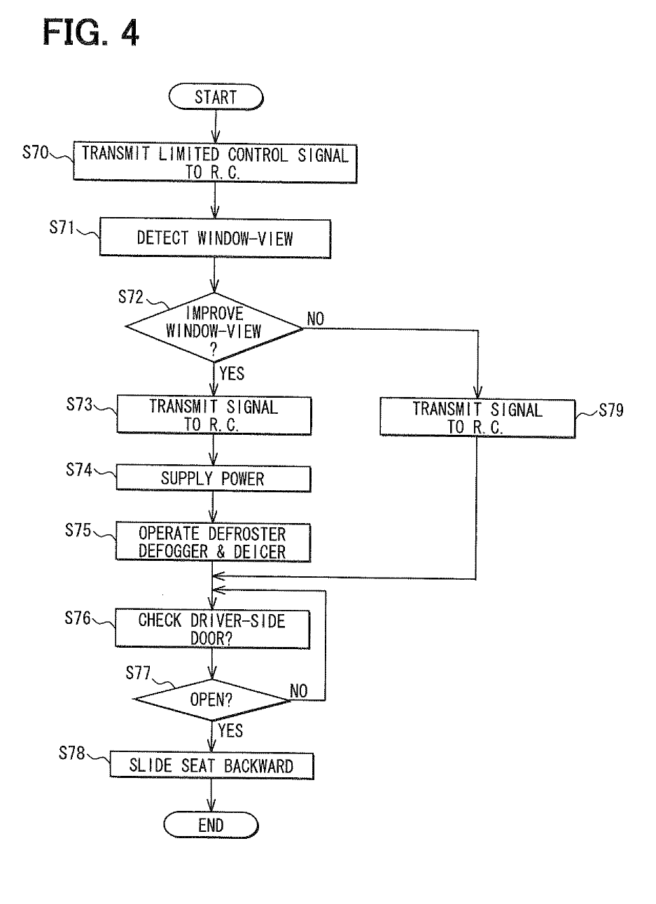

An example of modifications of the limited control process that is performed when the residual battery capacity is lower than the predetermined level is shown in FIG. 4. The process shown in FIG. 4 is performed after it is determined that the residual battery capacity is lower than the predetermined level at step S13 shown in FIG. 2. In this modified process, only the window-view conditions are adjusted without adjusting air conditions in the passenger compartment.

At step S70, information to indicate commencement of the limited control process is transmitted to the remote controller 10 to notify this fact to the user. At step 571, the window-view conditions are detected by the window-view detector 23. At step S72, whether the adjustment (or improvement) of the window-view conditions is necessary or not is determined. If the window-view adjustment is necessary, the process proceeds to step S73, where information showing the detection result of the window-view detector 23 is transmitted to the remote controller 10. If the window-view adjustment is not necessary, the process proceeds to step S79, where this fact is informed to the remote controller 10 and the process proceeds to step S76.

At step S74, electric power is supplied to devices to be operated for improvement of the window-view conditions. At step S75, the defroster, the defogger and the deicer, whichever necessary, are operated according to signals from the ECU 21. Thus, the window-view conditions are improved to the predetermined levels. At step S76, the state of driver-side door is confirmed. At step S77, whether the driver-side door is opened or not is determined. If the drover-side door is opened, the process proceeds to step S78, where the driver seat is shifted backward to make more space for the driver to get into the vehicle. If not, the process returns to step S76 to repeat steps S76 and S77. Then, the process comes to the end.

In the modified process described above, the buttery power consumption is further suppressed in the limited control process. Nevertheless, at least the window-view conditions are improved even when the residual battery capacity is low.

While the present invention has been shown and described with reference to the foregoing preferred embodiment, it will be apparent to those skilled in the art that changes in form and detail may be made therein without departing from the scope of the invention as defined in the appended claims.

What is claimed is:

1. An adjusting system for adjusting conditions in passenger compartment of an automotive vehicle, the adjusting system comprising:
an on-board system, mounted on the automotive vehicle, for adjusting conditions in the passenger compartment, the on-board system including a wireless communication device, a window-view detector, an air-condition detector and a detector for detecting a residual battery capacity; and
a remote controller which is able to wirelessly communicate with the wireless communication device of the on-board system, wherein:
the remote controller transmits a command to adjust conditions in the passenger compartment upon operation by a user before the automotive vehicle is driven;
the on-board system adjusts the conditions in the passenger compartment to predetermined conditions based on signals from the window-view detector and the air-condition detector; and
ways of adjusting either the air-condition or the window-view are selected according to the residual battery capacity.

2. The adjusting system as in claim 1, wherein: the on-board system adjusts the air-condition in the passenger compartment by operating an air-conditioner mounted on the vehicle if the residual battery capacity detected by the detector is higher than a predetermined level; and the on-board system adjusts the air-condition in the passenger compartment by operating either power windows or window shades, or both, if the residual battery capacity is lower than the predetermined level.

3. The adjusting system as in claim 1, wherein: the on-board system adjusts both of the air-condition and the window-view if the residual battery capacity is higher than a predetermined level; and the on-board system adjusts only the window-view if the residual battery capacity is lower than the predetermined level.

4. The adjusting system as in claim 1, wherein: the wireless communication device transmits information regarding the conditions in the passenger compartment detected by the air-condition detector and the window-view detector to the remote controller; and the remote controller outputs the transmitted information for the user.

5. A method of adjusting air-condition and window-view in a passenger compartment of an automotive vehicle before the vehicle is driven, the air-condition including temperature and humidity in the passenger compartment, and the window-view includes visibility through windows of the passenger compartment, the method comprising:
wirelessly transmitting a command to adjust the air-condition and the window-view to desired levels from a remote controller to an on-board system, before driving the vehicle;
detecting a residual capacity of an on-board battery upon receipt of the command;
detecting the air condition and the window-view by on-board detectors; and
adjusting both the window-view and the air-condition in the passenger compartment to the desired levels by operating on-board devices including a power-consuming air-conditioner, if the residual battery capacity is higher than a predetermined capacity, or adjusting only the window-view by operating on-board devices, which consume only limited power, including a defogger and a deicer, if the residual battery capacity is lower than the predetermined capacity.
